(19) United States
(12) Patent Application Publication
(10) Pub. No.: US 2010/0188321 A1
(43) Pub. Date: Jul. 29, 2010

(54) LED DISPLAY DEVICE WITH HIGH TRANSMITTANCE

(76) Inventor: George YEN, Chung Ho City (TW)

Correspondence Address: Muncy, Geissler, Olds & Lowe, PLLC, 4000 Legato Road, Suite 310, FAIRFAX, VA, 22033, US

(21) Appl. No.: 12/359,840

(22) Filed: Jan. 26, 2009

(51) Int. Cl. G09G 3/32

(52) U.S. Cl. 345/82

(57) ABSTRACT

A LED display device with high transmittance is revealed. The LED display device with high transmittance consists of a plurality of horizontal display strips arranged at certain intervals and parallel to one another, a plurality of support members for connecting and supporting the plurality of display strips, a power cable together with a signal wire for sending electrical signals and driving the LEDs to emit light. The horizontal display strip includes a long horizontal frame, a strip circuit board, and a plurality of light emitting diodes (LED). The LED is side LED arranged on the circuit board at equal intervals and the circuit board is horizontally mounted in a long chamber of the long horizontal frame so as to reduce forward height as well as forward area of the long horizontal frame for increasing light transmittance of the LED display device.

### BACKGROUND OF THE INVENTION

The present invention relates to a LED display, especially to a LED display device that uses a plurality of horizontal display lamps for minimizing forward height and area thereof. A plurality of support members is arranged among the plurality of horizontal display lamps that are disposed at certain intervals and parallel to one another so as to improve transmittance of the device.

LED (light-emitting diode) has been applied to display systems widely. However, conventional display systems have a problem of no transmittance due to disposition of the components. In order to improve above shortcoming, now a transmissive display system is available now. By a plurality of top LEDs arranged vertically at certain intervals, the LED emits light from top of the system and the light projects out of the system.

Refer to FIG. 1, a transmissive display system with better design is revealed. A plurality of top LED 11 is arranged on a circuit board 12 at equal intervals and direction of light emitted from the top LED 11 is perpendicular to the circuit board 12. The electronics that control and driven the LED are also set on the circuit board 12 so that the circuit board 12 requires larger area. The circuit board 12 is mounted in a horizontal frame 13. A plurality of horizontal frames 13 at equal intervals and a plurality of vertical frames 14 are used as connection channels for control signals and power sources of upper and lower circuits so as to from a display system. Moreover, the whole display system is divided into a plurality of modules 15 with a size of 80 cm*80 cm and connected with one another by a plurality of connecting members 16, as shown in FIG. 2.

Refer to FIG. 1, the area labeled with A′. Take two adjacent top LED 11 with an interval of 50 mm as an example. Transmittance of a single dot is calculated as follows: area of a single dot is 2500 mm² (50 mm*50 mm=2500 mm²). The area occupied by the horizontal frames B′ is 550 mm² (11 mm*50 mm=550 mm²). The area occupied by the vertical frames C′ is 300 mm² (6 mm*50 mm=300 mm²). The transmittance is equal to the equation: (A′−B′−C′)/A′. Thus it's 66%((2500−550−300)/2500=66%).

It is learned from the above description that the transmittance of general transmissive display systems is only 60˜70%. Furthermore, the connecting member 16 and power cables 17 also occupy certain area of the circuit board 12. The transmittance is further reduced. Thus there is a need to provide a display system with high transmittance.

### SUMMARY OF THE INVENTION

Therefore it is a primary object of the present invention to provide a LED display device with high transmittance that includes a plurality of horizontal display strips arranged at certain intervals and parallel to one another, a plurality of support members connected with and supporting the plurality of horizontal display strips, a power cable connected to the display strip for providing power, and a signal wire connected to the display strip for sending electrical signals. The horizontal display strip mainly consists of a long horizontal frame, a strip circuit board, and a plurality of light emitting diodes (LED). By the power cable and the signal wire, the LED is driven to emit light for display effects. A long chamber is arranged inside the long horizontal frame for mounting the strip circuit board, and the plurality of LEDs. The LEDs are side LEDs and are disposed on the strip circuit board along the horizontal direction at equal intervals. The strip circuit board is mounted into the long chamber of the long horizontal frame horizontally so as to reduce forward height of the long horizontal frame and further decrease forward area of the display strip or the long horizontal frame for increasing transmittance of the display device.

It is another object of the present invention to provide a LED display device with high transmittance in which the support member and the power cable further assemble with each other to form a cable support member. By the cable support members connected with the plurality of horizontal display strips arranged at certain intervals and parallel to one another, the volume of the support member as well as of the power cable is reduced. Therefore, transmittance of the electronic display device with high transmittance is further increased.

### BRIEF DESCRIPTION OF THE DRAWINGS

FIG. 1 is a schematic drawing showing structure of a prior art of top emission LED;

FIG. 2 is a schematic drawing showing structure of a prior art of top LED module;

FIG. 3 is a schematic drawing showing an embodiment of the present invention;

FIG. 4 is a partial enlarged view of a display strip according to the present invention;

FIG. 5 is a cross sectional view of a support member according to the present invention;

FIG. 6 is a schematic drawing showing another embodiment of the present invention.

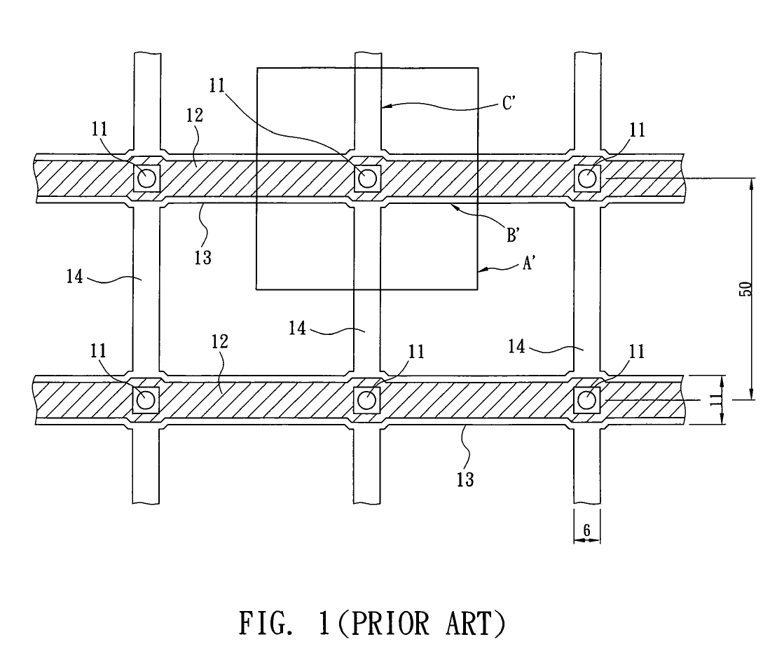

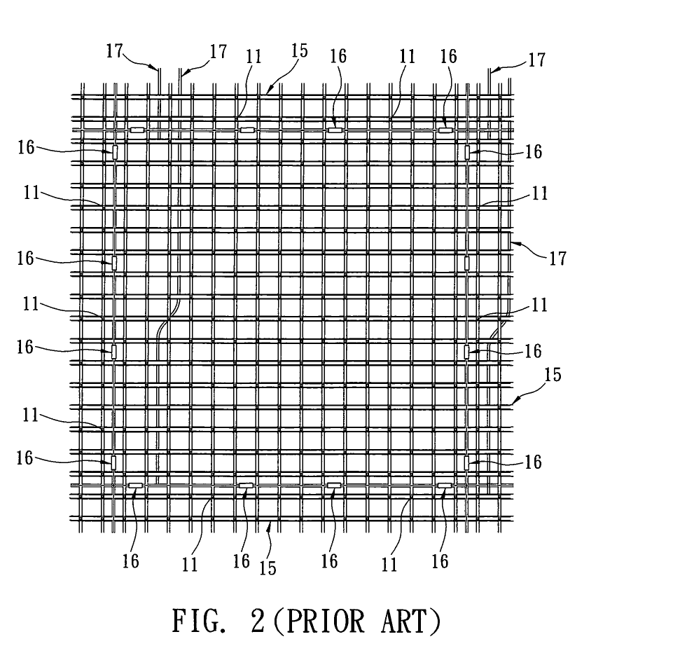

### DETAILED DESCRIPTION OF THE PREFERRED EMBODIMENT

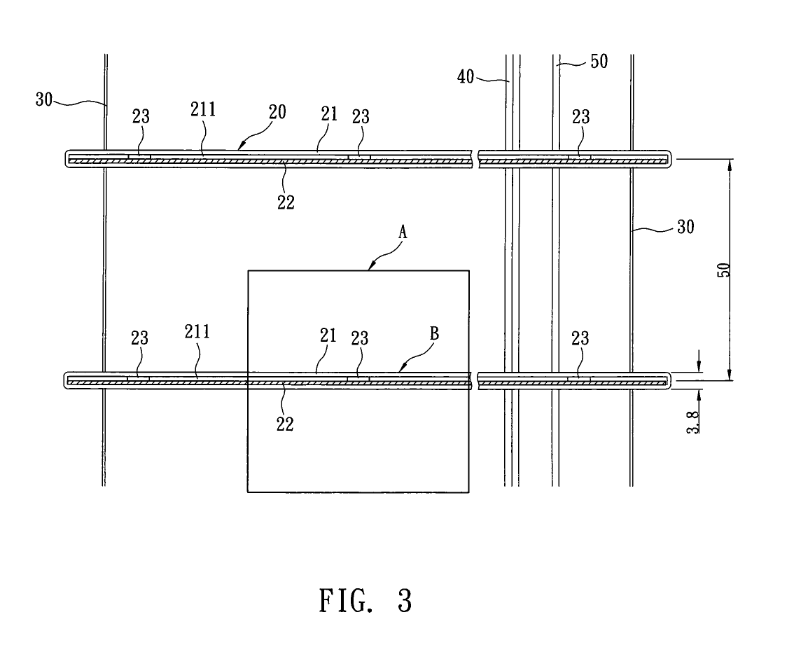

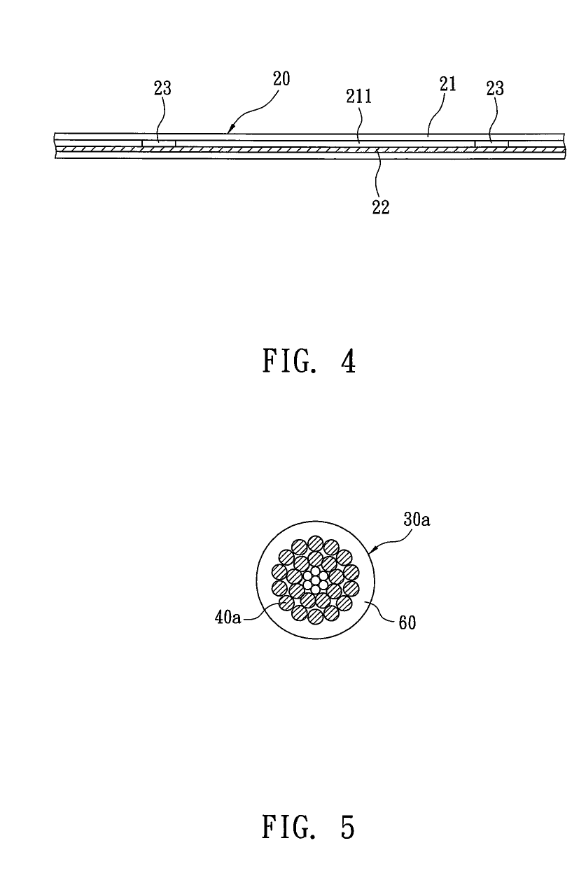

Refer to FIG. 3 & FIG. 4, a LED display device with high transmittance of the present invention consists of a plurality of horizontal display strip 20 arranged at certain intervals and parallel to one another, a plurality of vertical support members 30, a power cable 40 and a signal wire 50. The horizontal display strip 20 is formed by a long horizontal frame 21, a strip circuit board 22, and a plurality of light emitting diodes (LED) 23. The height of the long horizontal frame 21 is about 3.8 mm and the material of the long horizontal frame 21 is not limited. The material can be transparent such as plastic. A long chamber 211 is arranged inside the long horizontal frame 21 for mounting the strip circuit board 22, and the plurality of LEDs 23. The height of the strip circuit board 22 is about 0.8 mm and the strip circuit board 22 is mounted into the long chamber 211 of the long horizontal frame 21 horizontally. The LEDs 23 are side LEDs with the height of about 1 mm and are disposed on the strip circuit board 22 along the horizontal direction at equal intervals.

The support member 30 is for connecting and supporting the plurality of display strips 20. Thus the support member 30 is made from material with good strength, toughness and weather resistance such as steel wires so as to support and hang the whole LED display device with high transmittance and arrange the device according to buildings.

The power cable 40 is to connect the display strips 20 with a power source for supplying power to the display strips 20.

The signal wire 50 is connected to the display strips 20 for transmitting electrical signals. Thus the LEDs 23 are driven by the power cable 40 and the signal wire 50 to emit light for display effects.

Refer to FIG. 3, the area labeled with A. Take two adjacent top LED 23 with an interval of 50 mm as an example. Transmittance of a single dot is calculated as follows: area of a single dot is 2500 mm² (50 mm*50 mm=2500 mm²). The area occupied by the horizontal frames B is 190 mm² (3.8 mm*50 mm=190 mm²). The area occupied by the vertical frames C is zero (C=0). The transmittance is equal to the equation: (A−B−C)/A. Thus it's 92.4%((2500−190−0)/2500=92.4%).

Thus it is realized from the above description that the whole transmittance of the LED display device with high transmittance formed by a plurality of horizontal display strips 20 arranged horizontally and a plurality of vertical support members 30 according to the present invention is no less than 85%.

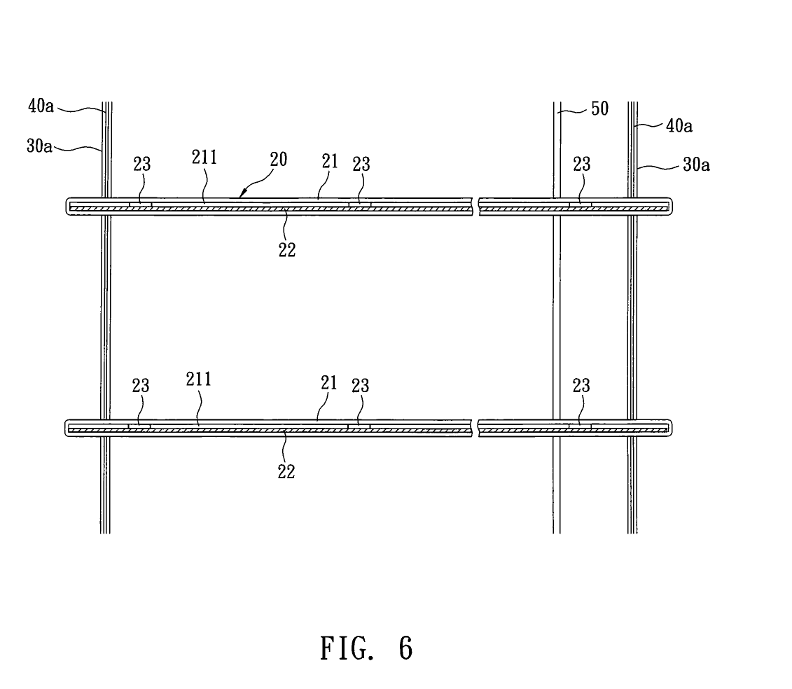

Refer to FIG. 5 & FIG. 6, the LED display system with high transmittance of the present invention further includes a cable support member 30a formed by integration of the vertical support member 30 and the power cable 40. The cable support member 30a consists of steel wires for support in the center, a power cable 40a such as copper wires outside the center, and a cover layer 60 made from material with insulation effect such as polyvinyl chloride (PVC) on the surface. The PVC material can be transparent. The cable support member 30a connects with and supports the plurality of display strips 20 so as to reduce volume occupied by the support members 30 and the power cable 40. Thus the transmittance of the display system is further enhanced to 90.9% or above.

Moreover, the long horizontal frame 21 of the display strip 20 and the PVC cover layer 60 of the cable support member 30a are made from transparent material so that the transmittance of the display system according to the present invention is further raised to 95.4% or above.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A light-emitting diode (LED) display device with high transmittance comprising a plurality of horizontal display strips disposed at certain intervals and parallel to one another, a plurality of support members, a power cable and a signal wire; wherein the horizontal display strip includes a long horizontal frame, a strip circuit board, and a plurality of light emitting diodes (LED); a long chamber is arranged inside the long horizontal frame for mounting the strip circuit board, and the plurality of LEDs while the LEDs are side LEDs and are disposed on the strip circuit board along the horizontal direction at equal intervals;
the support members are connected vertically and are supporting the plurality of horizontal display strips arranged at certain intervals and parallel to one another;
the power cable is connected to the display strips for providing power;
the signal wire is connected to the display strips for transmitting electrical signals; by the power cable and the signal wire, the LEDs are driven to emit light for display effects;
wherein the plurality of side LEDs are disposed on the strip circuit board along the horizontal direction at equal intervals and the strip circuit board is mounted into the long chamber of the long horizontal frame horizontally so as to reduce forward height of the long horizontal frame and further decrease forward area of the display strip and the long horizontal frame for increasing transmittance of the LED display device.

2. The device as claimed in claim 1, wherein the vertical support members are made from steel wires.

3. The device as claimed in claim 1, wherein the long horizontal frame is made from transparent material.

4. The device as claimed in claim 1, wherein the support member and the power cable assemble with each other to form a cable support member.

5. The device as claimed in claim 4, wherein the cable support member includes steel wires in a center, a power cable outside the steel wires, and a cover layer on the most outer side.

6. The device as claimed in claim 5, wherein the cover layer is made from polyvinyl chloride (PVC).
